(19) United States
(12) Patent Application Publication
(10) Pub. No.: US 2025/0061872 A1
(43) Pub. Date: Feb. 20, 2025

(54) A METHOD AND SYSTEM FOR DELIVERING A PRE-SELECTED AMPLIFIED OUTPUT FOR A STRINGED INSTRUMENT

(71) Applicant: AUSTRALIAN NATIVE MUSICAL INSTRUMENTS PTY LTD, Bayswater, Victoria (AU)

(72) Inventor: Paul GALE, Bayswater, Victoria (AU)

(21) Appl. No.: 18/723,075

(22) PCT Filed: Dec. 21, 2022
(86) PCT No.: PCT/AU2022/051548

§ 371 Date: Jun. 21, 2024

(30) Foreign Application Priority Data
Dec. 21, 2021 (AU) 2021904155

(51) Int. Cl. G10H 3/18

(52) U.S. Cl. CPC G10H 3/181; G10H 2220/515

(57) ABSTRACT

A method for delivering a pre-selected amplified output of a set of strings of a stringed instrument including providing a magnet member associated with each string of the stringed instrument wherein each magnet member is configured to be arranged in a coil of a pickup mountable to the stringed instrument for detection and amplification of the vibration of the respective string, and adjusting each of the magnet members such the strength of the magnetic flux output by that magnet member is in a pre-determined relationship with the strength of magnetic flux output by each of the other magnet members, wherein the magnetic flux output by each of the magnet members facilitates amplification of the vibration of its respective string, when so vibrating, such that the amplified outputs of each of the strings combine to produce a pre-selected total amplified output.

### FIELD OF THE INVENTION

The present invention relates a method and system for delivering a pre-selected output of strings of a stringed instrument. This disclosure also describes an apparatus for the method and system.

### BACKGROUND TO THE INVENTION

To amplify the sound from a stringed instrument which has steel strings, such as a guitar, a transducer such as a magnetic pickup is often used. A simple magnetic pickup has a coil of fine gauge copper wire, typically enamelled for insulation, wound about a former referred to as a bobbin. At least one permanent magnet or series of magnets, are located within the pickup to create a magnetic field in order to magnetize the strings.

A known pick up referred to as a ‘single-coil’ pickup for a 6-string electric guitar is shown in FIG. 1 where a row of vertically oriented, equidistantly horizontally spaced magnetic rods is provided within the coil. These rods are also known as ‘pole-pieces’ due to their North South polarity. The pickup is usually mounted underneath and across the strings such that each one of the ends of the permanent magnets sits under a respective string and induces a magnetic field in the string. The strings vibrate when plucked and vary the associated magnetic field in accordance with these vibrations and an alternating current is generated in the coil of the pickup. The pole pieces are typically formed from permanent magnets made from magnetizable materials such as steel, iron, or alloys for example Aluminium-Nickel-Cobalt (AlNiCo).

Alternatively, in a more economical version of a ‘single-coil’ pickup, the pole pieces are formed of a magnetizable material such as iron or steel and they are arranged to be in contact with one or more permanent magnets fitted to the base of the bobbin which induces a magnetic field in all the pole pieces. The permanent magnet/s are typically made from a low-cost ceramic material.

The Humbucker is another type of pickup which has two bobbins which are wired out of phase to cancel electronic hum, as illustrated in FIG. 2. The bobbins are mounted on a base plate that has a permanent magnet. Each bobbin has a series of equidistantly spaced holes which each receive a pole-piece. The holes are spaced such that the pole-pieces are aligned to a respective string. In one bobbin, the pole pieces are formed of iron or steel rods known as ‘slugs’ while the other bobbin has a set of pole-pieces which allows the pole-pieces to be movable closer to or further away from the string so as to be able to adjust the output of the string when amplified.

Ideally, each individual string on an instrument should have the same volume otherwise known as “level” when amplified, to produce a smooth natural amplification of the instrument; this is known as a ‘balanced output’.

There are many factors that affect the sonic qualities of the pickup and its output level. These include the number of turns and the gauge of the coil wire, the type and strength of the magnets and subsequent magnetic field, all factors which affect the inductance and therefore the resonant frequency of the pickup which in turn affects the frequency response and the output level. The physical dimensions of the pickup bobbins and the position of the pickup along the length of the guitar strings also plays a great part in how the pickup will sound.

The strings must be made of a material that can have a magnetic field induced into it, this quality is typically termed ‘permeability’. Typically, strings that can be used with a magnetic pickup have a permeable, carbon steel core usually plated with nickel or nickel alloy. Nickel, while increasing the corrosion resistance of the string, also, has relative high permeability which adds to the overall permeability of the strings. Lower frequency/tension strings can have one or more windings over the steel core in different thickness and permeabilities, which can be formed by different alloys such as nickel, bronze or phosphor bronze, to achieve a particular tension or mass and also to achieve different sonic qualities.

Phosphor bronze strings also use a permeable, carbon steel core, but the extra winding/s are made from a phosphor bronze alloy which has relatively low permeability (virtually non-magnetic). This type of string is usually used for its arguably superior sonic qualities, but the overall relatively low permeability of the strings makes them not so suitable for conventional magnetic pickups.

While the pickups that use magnets as polepieces are relatively easy to make, and they are sensitive to small vibrations of the strings and deliver a wide frequency response, the disadvantages are that the relative distance of the magnet pole pieces to the strings must be set when the pickup is made. Therefore, there is little or no adjustment of the magnetic fields in this type of pickup to be able to adjust the output of each string. Further, if different types of strings are used, for instance a plain string or a wound string, then there is a different response in the output level from that string because the mass difference (per length) and tension of the string will affect the magnetic field in its magnet pole-pieces differently and thereby induce a different amount of current in the pickup coil.

Furthermore, the fingerboards of stringed instruments such as guitars are generally curved and have radiuses of about 18.5 cm to 30 cm. The strings are generally strung equidistantly spaced from the fingerboard and therefore generally follow the same radius of the fingerboard. Magnets of differing lengths also must be used to follow the radius of the strings. If a magnet is set for a plain string and a wound string is used there will be a different response in the output level from the string due to the mass difference and tension of the string. Magnets set too close to the strings also cause output level balance problems and can cause anomalies in the strings' vibration often also affecting the intonation of the string.

In a humbucker pickup arrangement, the magnet is set under and in between the bobbins and adjustable threaded steel polepieces are usually fitted to one bobbin only, the threaded pole pieces allowing a small amount of adjustment to the output level of each string. Unfortunately, the adjustment capability is limited and if some screws are adjusted at a much different height to the neighbouring screws, this is generally considered aesthetically undesirable.

It would be desirable to address or at least obviate the above discussed disadvantages of previously known pickups.

It would also be desirable to deliver a balanced total amplified output or a pre-selected total amplified output for the strings of a stringed instruments especially where, each of the strings have differing qualities, for example, have different permeabilities, different tension/mass and/or materials.

Any discussion of documents, devices, acts or knowledge in this specification is included to explain the context of the invention. It should not be taken as an admission that any of the material formed part of the prior art base or the common general knowledge in the relevant art on or before the priority date of the claims herein.

### SUMMARY OF THE INVENTION

According to an aspect of the present invention there is provided a method for delivering a pre-selected amplified output of a set of strings of a stringed instrument, the method comprising the steps of: providing a magnet member associated with each string of the stringed instrument wherein each magnet member is configured to be arranged in a coil of a pickup mountable to the stringed instrument for detection and amplification of the vibration of the respective string; and adjusting each of the magnet members such the strength of the magnetic flux output by that magnet member is in a pre-determined relationship with the strength of magnetic flux output by each of the other magnet members, wherein the magnetic flux output by each of the magnet members, facilitates amplification of the vibration of its respective string, when so vibrating, such that the amplified outputs of each of the strings combine to produce a pre-selected total amplified output.

In an embodiment the pre-selected total amplified output is a combination of amplified outputs of each vibrating string where the amplified output of each string has the same volume level. This produces a so-called ‘balanced’ output which is considered to be a ‘natural’, ‘smooth’ and highly desirable sound. Optionally, the pre-selected total amplified output corresponds to amplified outputs of the strings having volume levels corresponding to respective strings of a specific pre-selected instrument or playing style. Thus, alternative pre-selected total amplified outputs may be where the acoustic volume level of each string when so amplified has a relationship with each other string so as to mimic the volume levels of strings of specific vintage instruments or certain styles of music, i.e. jazz or blues.

In the latter regard, it has been observed that vintage electric guitars, such as a Fender Stratocaster or Fender Telecaster of the type fitted with pickups that have permanent magnet pole pieces, produce a characteristic sound due to ageing of the magnets and this sound has been found to be highly desirable, making these guitars very collectable and expensive. As such, reproductions of classic guitars have often attempted to reproduce the classic sound using magnets that do not have the same quality as those that have aged. Most of these attempts have been only partly successful, but the ability of the present method to adjust the magnetic flux of each individual magnet member, in accordance with a pre-selected (and desired) amplified output level, allows a modern guitar to mimic the classic sound of a vintage guitar more closely.

In one embodiment the method can comprise a step of adjusting each of the magnet members by magnetizing each of the magnet members to a predetermined level such that each of the magnet members outputs a respective pre-determined magnetic flux. Prior to magnetizing each of the magnet members to a pre-determined level, the method can include the step of demagnetizing each of the magnet members. The demagnetization of the magnet members can comprise subjecting each of the magnet members to an alternating (AC) magnetic field. The magnetization of the magnet members can comprise subjecting each of the magnet members to a DC magnetic field.

The step of magnetization of the magnet members can further comprise magnetizing each of the magnet members to a higher magnetization charge level then de-magnetizing each of the magnet member to a predetermined charge level so that each of the magnet member outputs the respective predetermined magnetic flux.

In the steps of magnetization or de-magnetization, the AC or DC magnetic fields can comprise a series of magnetic pulses in a pulse envelope. In the step of de-magnetization, the magnitude of the alternating AC magnetic field can be gradually reduced from a higher magnitude to a lower magnitude where each succeeding pulse is of lesser power than the one preceding it. In the step of magnetization, the magnitude of the alternating AC magnetic field can be gradually increased from a higher magnitude to a lower magnitude where each succeeding pulse is of greater power than the one preceding it.

The magnitude of the pre-determined magnetic flux output by one of the magnet members can be determined with respect to the permeability of the respective string which vibration is being amplified. The magnitude of the pre-determined magnetic flux output by one of the magnet members can be determined with respect to the material composition and/or size of the least one magnet members. The magnitude of the pre-determined magnetic flux output by one of the magnet members can be determined with respect to the string tension of the string which vibration is being amplified. The magnitude of the pre-determined magnetic flux output by one of the magnet members can be determined with respect to the acoustic properties of the stringed instrument and/or the properties of the pickup.

The step of adjusting one of the magnet members can include adjusting the at least one magnet member to output a higher magnetic flux for a respective string having a lower permeability than at least one other string in the set of strings. The string having a lower permeability can be a phosphor bronze string.

The magnet member can be removable from the pickup for adjustment of the magnetic flux to the predetermined output and replaceable thereafter. Optionally, the adjustment of the magnet members can be made in-situ in the pickup on the instrument.

After the step of demagnetization of the magnet member, the method includes the step of replacing or inserting the magnet member in the pickup and wherein the adjustment of the magnetic flux of magnet member(s) to the predetermined output is made in the pickup. Preferably, all the magnet members of the pick-up are demagnetized before being received in the pickup for assembly of the pickup, before adjustment of the magnetic flux of magnet member(s) to the predetermined output. Even more preferably, the pickup is wound with a metal coil and/or wax-dipped before adjustment of the magnetic flux of magnet member(s) to the predetermined output.

Adjustment of one of the magnet members can include altering the mass of each of the magnet members with respect to each string such that each of the magnet members outputs the respective pre-determined magnetic flux.

According to a further aspect of the present invention, there is provided a method for delivering a pre-selected amplified output of strings of a stringed instrument, the method comprising the steps of: providing a magnet member for each string of the stringed instrument wherein the magnet member is configured to be arranged in a coil of a pick-up; adjusting the mass of each of the magnet members such the strength of the magnetic flux output by that magnet member is in a pre-determined relationship with the magnetic flux output by each of the other magnet members, and wherein the magnetic flux output by each of the magnet members, facilitates amplification of the vibration of its respective string, when so vibrating, such that the amplified outputs of each of the strings combine to produce a pre-selected total amplified output.

The amplified output may be a current which is an amplification of the coil current generated by vibrations of the respective string. Alternatively, the amplified output may be a sound which is an amplified representation of the sound of the vibration of the respective string.

The or each magnet member may have at least one magnet element which can be attachable to and removable from the magnet member for increasing or decreasing the mass of the or each magnet member. The or each magnet element can be attachable and/or removable to an end portion of the magnet member, the end portion of the magnet member being inwardly directed towards the instrument so that the end portion is hidden from view.

Adjusting the mass includes removing mass by drilling or cutting the magnet members.

According to another aspect of the present invention, there is provided a magnetic pickup having a magnet member wherein the magnetic flux output of each of the magnet members is adjusted for a pre-selected total amplified output by a method as described above.

According to a further aspect of the present invention, there is provided a method of determining the magnetic flux output of magnet members of a pickup for a stringed instrument for delivering a pre-selected amplified output of the strings of the instrument, including the step of determining the resultant magnetic flux output from a selected magnet member by the method as described above by collecting data of the resultant magnetic flux output when varying one or more the following parameters: magnet member material composition, magnet member size, string material composition, string mass per length, string permeability, string tension, acoustic properties of the stringed instrument and properties of the pickup. The method can comprise use of the determination of each magnetic flux output in any of the methods of adjusting the magnet members as described above.

According to a yet another aspect of the present invention, there is provided a system for delivering a pre-selected amplified output of strings of a stringed instrument, the system comprising an apparatus for adjusting the magnetic fields of a set of magnet members, the magnet members being configured for use in a pick-up such as a magnetic pick-up, the apparatus comprising: at least one pair of electromagnets, a pole of one of each pair being arranged to face the opposite pole of the other of the pair and having a space between the oppositely facing poles for receiving one of the magnet members; a power supply connected to each of the at least one pair of electromagnets for adjustment of the magnetic flux of the magnet member received in the space; a control device connected to the power supply for controlling the power supply, the control device comprising at least one processor, a memory and a set of instructions stored in the memory for adjusting each of the magnet members to a predetermined level the magnetic flux output by each of the magnet members, facilitates amplification of the vibration of its respective string, when so vibrating, such that the amplified outputs of each of the strings combine to produce a pre-selected total amplified output.

The amplified output may be a current which is an amplification of the coil current generated by vibrations of the respective string. Alternatively, the amplified output may be a sound which is an amplification of the vibration of the respective string.

The system can comprise multiple pairs of electromagnets and wherein one of the multiple pairs of electromagnets is for adjusting each magnet member of the pickup.

The step of adjusting each of the magnet members can comprise magnetizing each of the magnet members to a predetermined level such that each of the magnet members outputs a respective pre-determined magnetic flux.

The system can further include additional pairs of electromagnets for adjusting magnet members of a second pickup. Thus advantageously, the magnetic flux of the magnet members of two or more pickups can be adjusted simultaneously. In a preferred embodiment, a first set of pairs of electromagnets can be configured to adjust the magnetic flux of magnet members of the first pickup, while a second set of pairs of electromagnets can be configured to adjust the magnetic flux of the second pickup. The magnet members the first or second pickup are optionally adjusted while received in the pickup.

The step of adjusting each of the magnet members can comprise altering the mass of the at least one magnet member such that each of the magnet members outputs a respective pre-determined magnetic flux.

According to another aspect of the present invention, there is provided an apparatus configured for use in a system as described above.

Each of the magnet members can be a permanent magnet. The permanent magnet substantially can comprise one or more of the following: alloys comprising aluminium, nickel and cobalt, iron oxide and strontium carbonate.

### BRIEF DESCRIPTION OF THE DRAWINGS

An embodiment, incorporating all aspects of the invention, will now be described by way of example only with reference to the accompanying drawings in which:

FIG. 1 shows top and side views of a single coil pickup (prior art);

FIG. 2 shows top and side views of a humbucker pickup (prior art);

FIG. 3 is a flowchart of a method for delivering a pre-selected amplified output of strings of a stringed instrument according to a preferred embodiment of the present invention;

FIG. 4 is a circuit diagram of an apparatus for adjustment of magnet members of a pickup according to a further preferred embodiment of the present invention;

FIG. 5 is a first waveform of a power envelope for demagnetization of a magnet member;

FIG. 6 is a second waveform of the power envelope for demagnetization of a magnet member;

FIG. 7 is a third waveform of the power envelope for demagnetization of a magnet member;

FIG. 8 is a first waveform of a power envelope for magnetization of a magnet member;

FIG. 9 is a second waveform of the power envelope for magnetization of a magnet member;

FIG. 10 is a third waveform of a power envelope for de-magnetization of a magnet member after the magnetization step;

FIG. 11 is a graphical summary of the changing power envelope for demagnetization of a magnet member; and

FIG. 12 is a graphical summary of the changing power envelope for magnetization of a magnet member.

### DESCRIPTION OF PREFERRED EMBODIMENTS

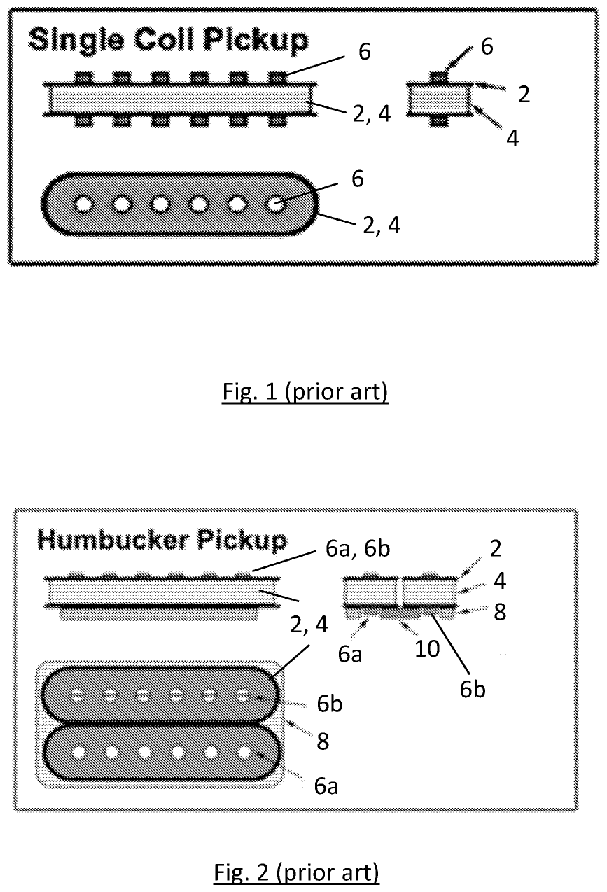

In FIG. 1 there is shown a prior art single coil magnetic pickup for a stringed instrument such as a guitar having a former 2 around which a coil 4 is wound, known as a ‘bobbin’, and multiple pole-pieces 6 received within the coil and equidistantly spaced. The pickup is connected to the stringed instrument such that an upper end of each of the pole-pieces is aligned under a respective metal string for detecting its vibration and amplifying it.

In FIG. 2 there is shown a prior art Humbucker magnetic pickup which has a pair of bobbins, each bobbin consisting of a former and coil 2, 4 which are wired out of phase to cancel electronic hum. The bobbins are mounted on a base plate 8 that has a permanent magnet 10. Each bobbin as a series of equidistantly spaced holes which each receive a pole-piece 6a, 6b (‘slugs’ 6a or threaded pole-pieces 6b) which is magnetised by the magnet 10 and the pole-pieces are spaced so that the pole-pieces 6a, 6b are aligned to a respective string when the pickup is connected to the instrument.

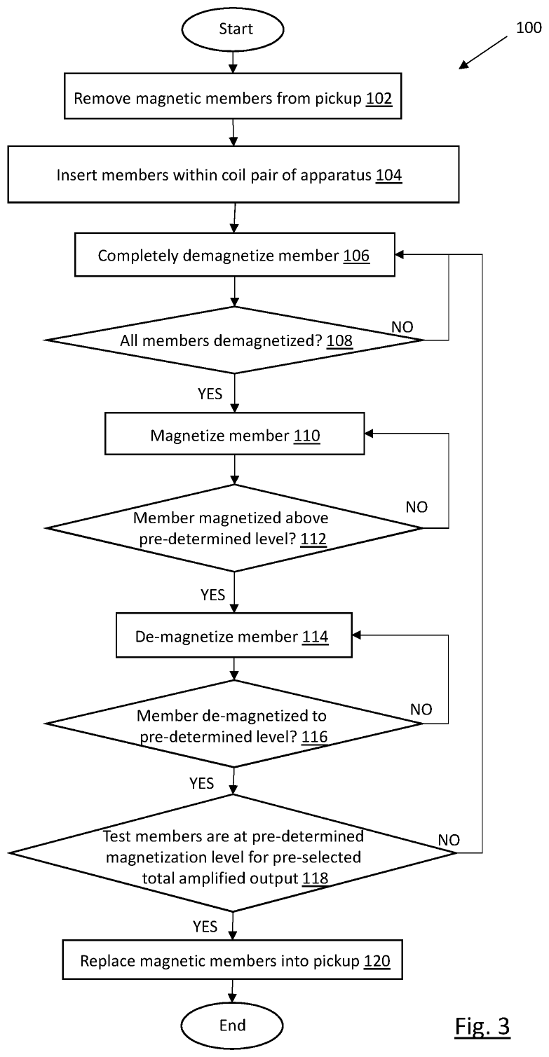

Referring now to FIGS. 3 to 10, there is provided a method 100, system and apparatus 150 for delivering a pre-selected amplified output of strings of a stringed instrument according to preferred embodiments of the present invention by a pickup such as a magnetic pickup and which is amplified by an amplification device. The present disclosure generally relates to magnetic pickups of the type discussed in the above paragraphs and is abbreviated to use of the word ‘pickup’ in the disclosure. The strings of the stringed instrument, for use with a magnetic pickup, are at least partially formed of metal material, such as a carbon steel core, and may have other materials wound about or coating the core, such as phosphor bronze strings which are preferred by some guitarists. The method 100, system and apparatus 150 are especially advantageous where the strings used are phosphor bronze strings because while the carbon steel core has a relatively high permeability, the outer coatings or windings are generally made of material which have very low permeability (almost non-magnetic).

In the description and examples, the stringed instrument may be a guitar however it will be understood that the stringed instrument is not limited to guitars but may encompass any instrument having one or more metal strings the vibrations of which are capable of being detected by a pickup, such as banjos, mandolins, bass guitar, violin, viola, harp, harpsichord, lute, sitar, ukulele, lute and the like.

The method 100 starts with providing a pickup such as a magnetic pickup, which has magnet members 20, which act as ‘pole-pieces’, equidistantly spaced within a coil or ‘bobbin’. Each of the magnet members 20 is a magnet capable of producing a pre-determined magnetic flux or ‘charge,’ such as a permanent magnet, and inducing a magnetic field in a metal or metal-containing string adjacent to it. The number and arrangement of magnet members 20 usually correlates to the number and spacing of strings.

Thus, for a six or 12-string guitar, there can be at least six magnet members in the case of a single coil pickup or twelve magnet members in the case of a humbucker pickup with two bobbins (six per bobbin). The 12-string guitar has six pairs of strings-a pair termed a “course”—so one magnet member will serve the string pairs or courses simultaneously. The number of magnet members is an integer number multiplied by the number of strings or courses of strings. For a four-string bass guitar, there can be at least four magnet members 20.

The magnet members 20, when in use in the pickup, are arranged, similar to those shown in FIGS. 1 and 2, where the members 20 are generally elongate-shaped, such as in the shape of a rod or cylinder and aligned perpendicular to a plane of the coil/bobbin. The pickup is generally mounted to a string instrument, such as a guitar, such that the end portions of each of the magnet members 20, in-situ, are adjacent and aligned, to a respective string, for translation of the vibration of that string to an electrical signal for amplification. While one magnet member 20 can be sufficient for its associated string, the pickup can have two or more magnet members 20 for each one of the strings, if so desired.

Stringed instruments such as a guitar typically use strings of different tensions, mass per length or material composition as discussed in the Background to the Invention above. Therefore, if each of the magnet members 20 is a magnet which outputs the same magnetic flux then the amplified output from each string is dependent on the type of string. and more typically its permeability. The present method 100 includes adjusting the magnetic flux output of each magnet member 20 which induces a magnetic field in its respective string to compensate for the varying permeability of different types of strings, for example, differing gauges, materials, mass and tension level, to produce an amplified output of each string that is preferred to produce a pre-selected total amplified output when all strings are vibrating where the sound from each string has a desired volume level.

Each of the magnet members 20, when adjusted to its respective predetermined charge, outputs a magnetic flux which is in a pre-defined relationship with each other of the strings so as to produce a pre-selected total amplified output having desired volume levels when all the strings are struck or strummed together. The total amplified output is defined in this disclosure as the combined amplified outputs of all the strings where each of the strings has an amplified output that has a volume level which has a specific relationship with the volume level of the amplified output of each other string when struck with substantially the same force.

For example, the pre-selected total amplified output may be a ‘balanced’ output where the magnetic flux output by each of the magnet members 20 causes its respective strings to vibrate and translates to an amplified electrical output which is equal in acoustic volume for each string. Therefore, advantageously, when all the strings are struck, the volume from each string is substantially the same or on the same ‘level’ for promotion of a ‘smooth’ and ‘natural’ amplified sound from the instrument. Other examples of pre-selected total amplified outputs may be where the acoustic volume of each string when so amplified have a relationship with each other which mimics specific vintage instruments or certain styles of music, i.e. jazz or blues.

For an instrument to be amplified using a magnetic pickup, the strings must be made of a material that can have a magnetic field induced into it. This quality in electromagnetic terms is called permeability and is basically a measure of how much magnetization can be induced in a material that has a magnetic field applied to it. There are various factors that affect permeability such as the materials comprising the string such as its core and windings and its gauge, i.e. its thickness.

The highest tension/frequency strings used on many acoustic and electric instruments are made from a single, carbon steel core usually plated with an alloy (often nickel) to prevent corrosion but which also increases permeability.

Lower tension strings also use a single, carbon steel core but require another winding wrapped on top of the core to achieve the tension and mass required to vibrate sufficiently and intonate (stay in tune) correctly along their length. The extra wrapped windings are often made from different alloys that have different sonic qualities and permeability; these alloys differentiate the types of string. Bass guitars often have two or more extra wrapped windings on top of the core.

Most types of strings are available in different gauges (thickness) that affects the string's tension, mass, and permeability.

There are two main types of strings used with one type referred to as nickel wound or just nickel strings often used on ‘electric’ guitars and the other referred to as phosphor bronze or just bronze strings generally used on acoustic guitars for their highly desirable acoustic qualities. Nickel strings typically use carbon-steel core strings with the extra wrapped winding/s made from a nickel alloy. This type of string works well with conventional magnetic pickups as both the core and the wrapped winding/s used in these strings have relatively high permeability.

Phosphor bronze strings also use a carbon-steel for the core, but the extra wrapped winding/s are made from phosphor bronze which has very low permeability (virtually non-magnetic). There are different varieties of these strings that use different ratios of zinc, copper and other metals to change the sonic properties, but these are still usually referred to as either phosphor bronze or just bronze strings.

The ability to adjust the magnetic flux output by a magnet member 20 addresses a major challenge in amplifying the output of a phosphor bronze string, which has very low permeability due to its phosphor bronze windings about a steel core, and therefore is amplified only weakly by traditional pickups. This is in comparison to nickel strings which have an overall high permeability and hence produce a higher output when amplified. Therefore, the present method 100 in a specific example allows for the magnet member 20 to be adjusted to output a high magnetic flux for effectively amplifying the output of the very low permeability phosphor bronze string. Accordingly, the magnet member 20 for amplifying a nickel string would be adjusted to output a lower magnetic flux for output of a similar amplified output but which would produce a volume level that is pre-selected in relation to the volume levels of the other strings, i.e. to have the same volume in the case of a ‘balanced’ output if that is pre-selected.

Similarly, a popular trend includes the modification or sale of guitars which mimic vintage electric guitar or vintage electric guitar sounds. In the pickups of older or vintage guitars, the magnet members 20 have typically weakened over time and therefore have been recognisable for their unique sounds. Therefore, advantageously, the present method 100 allows for adjustment of the magnetic flux output of magnet members 20 to cause a set of strings to have a total amplified output which has a specific relationship between the final volume level from each string resembling the total amplified output from a specific instrument, such as a vintage guitar. As discussed previously, it has been observed that vintage electric guitars, such as classic guitars fitted with single coil pickups such as a Fender Stratocaster or Fender Telecaster produce a highly desirable characteristic sound due to ageing of the magnets. As such, reproductions of classic guitars have often attempted to reproduce the classic sound using other types of magnets that have a lower flux output, but with other different magnetic characteristics to the original types used, resulting in a different sound to that of the correct type, aged magnets.

The present method advantageously allows adjustment of the magnetic flux of each individual magnet member, in accordance with a pre-selected (and desired) amplified output level, to allow a modern guitar to mimic the classic sound of a vintage guitar. Each string of the modern guitar therefore has a volume level similar to that of volume levels of a set of corresponding strings from a vintage guitar. Similarly, a pre-selected total amplified output could be an output where the strings have similar volume levels, once detected and amplified, which reproduces the corresponding volume levels of the respective strings for playing a particular style of music, such as blues or jazz, or vintage instruments which produce those styles of music.

A permanent magnet is made of a magnetizable material which contains a number of magnetic domains. Aligning more or less of these magnetic domains in a particular direction, termed magnetizing, will cause a permanent magnet to produce a higher or lower level of magnetic flux. Similarly, randomizing the alignment or orientations of magnetic domains of a permanent magnet, termed demagnetizing, will reduce the output of the magnetic flux. Thus, adjustment of the magnetic flux output by a magnet member 20 includes magnetizing or de-magnetization of the permanent magnet so as to increase or decrease the magnetic flux output of the permanent magnet.

With reference to FIGS. 3 to 10, there is described a method 100, system and apparatus 150 for magnetizing or de-magnetizing a permanent magnet for producing a pre-determined magnetic flux where the permanent magnets in the form of magnet members are configured for use in a pickup such as a guitar pickup. It is preferred that each of the magnet members 20 outputs a magnetic flux which accounts for the permeability of the string being amplified so that the pre-selected total amplified output is delivered by the pickup.

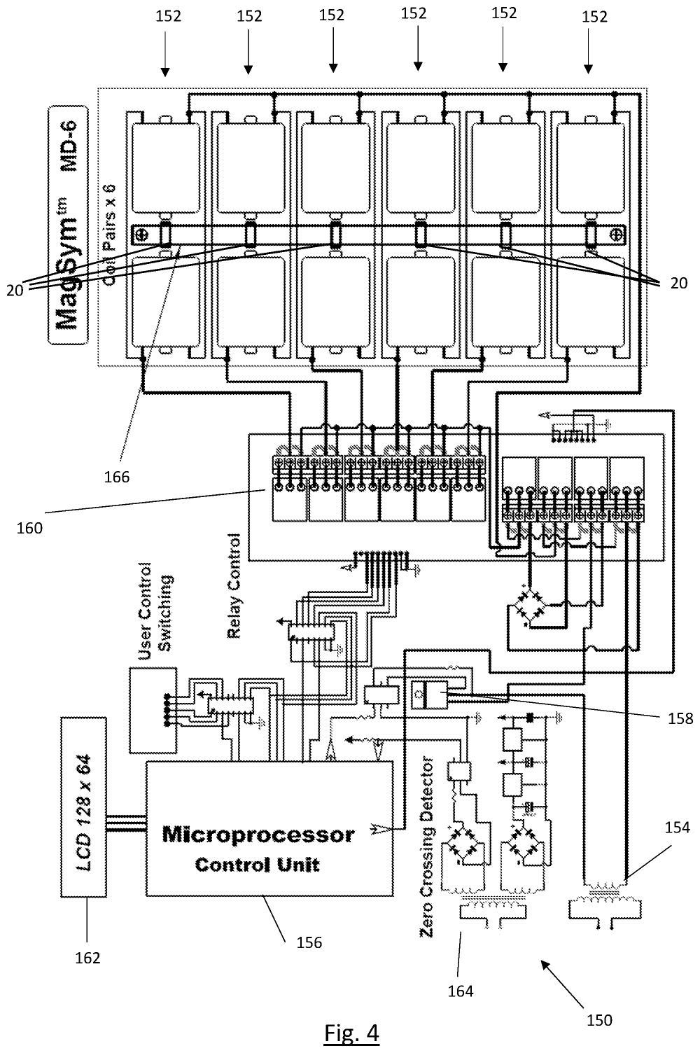

Specifically, FIG. 3 shows a flowchart for an example method 100 for magnetizing or de-magnetizing magnet members 20 while FIG. 4 shows a circuit diagram of an example apparatus 150 for performing the steps of that method 100.

First, the magnet members 20 are removed from the pickup in step 102 of the method 100, if removable, and placed so as to be received in the apparatus 150 as detailed further below. Alternatively, a set of new magnet members 20 may undergo the steps of the method 100 before assembly of the pickup or new stringed instrument. The applicant envisages that an apparatus 150 could also be configured for pickups that have non-removable magnets used to enable the magnet member 20 to be balanced in-situ in the pickup or in the stringed instrument itself. The magnet members 20 can be received in the apparatus 150 separately or placed into a cartridge 166 which is arranged to hold all the members 20 required for a particular pickup for the magnetization and de-magnetization process. Alternatively, the magnet member 20 is arranged to be received in the apparatus 150 while received in the pick-up.

To achieve a more accurate charge level for the magnetic member 20, the next steps 106 to 108 in the method is demagnetization of one of the magnet members 20 so that each magnet member 20 is completely de-magnetized or effectively de-magnetized. Next in steps 110 to 116, the magnet member 20 is then charged to a magnetization level slightly higher than what is required and then subjected to a much weaker demagnetization “force” to randomize as much as possible the magnetic alignment of the easily chargeable (and easily dischargeable) domains. The magnet member 20 is thus de-magnetized to the required pre-determined magnetization level which allows the magnet member 20 to output the magnetic flux as predetermined in step 116. This advantageously provide a magnet member 20 which does not only accurately provide a pre-determined magnetic flux but also assists to facilitate a constant magnetization level over a long period of time because the more likely temporary effect on the total charge level by the easily dischargeable domains is much reduced by this process.

The higher magnetization level can be at least 5% of the magnetized level which causes the magnet member 20 to output the required pre-determined magnetic flux. The higher level can be at least 10% of the magnetized level for output of the predetermined magnetic flux. The higher level could be less than 25% of the magnetized level for output of the predetermined magnetic flux. The higher level is less than 20% of the magnetized level for output of the predetermined magnetic flux.

In steps 106 to 116, each magnet member 20 can undergo the process of complete demagnetization, followed by the step of magnetization to a level higher than the required magnetization level, a so-called ‘higher magnetization level’ and then de-magnetized again to the predetermined magnetization level one at a time until all the magnets have been so treated in step 118. Alternatively, all the magnet members 20 can be de-magnetized one at a time in sequence, then each of the magnet members 20 can be magnetized to its individual higher level one at a time in sequence before each of the magnet members 20 are de-magnetized to each individual pre-determined level again one at a time in sequence.

At each step 108, 112, 118 of the method 100 discussed above, the magnet members 20 can be tested to check if each magnetization or de-magnetization step has been completed successfully, otherwise each respective step 108, 112, 118 is repeated.

At step 120, once it has been confirmed that the magnet members 20 are all at the predetermined magnetization level, the magnet members 20 can be installed in the pickup for use. If the magnet members 20 were magnetized in a cartridge, the magnet members 20 are first removed from the cartridge before re-installation. Optionally, the magnet members 20 are separately de-magnetized in steps 106 to 108, before being assembled in the pick-up. This makes the pick-up easier to handle and assemble, especially during the coil winding process and wax-dipping. The magnet members 20 can then be magnetized according to the steps 110 to 118 while in the pickup, which then obviates the need to perform step 120.

The process of magnetizing permanent magnets to different magnetization levels is complex due to the variable nature of the materials in permanent magnets. In simple terms, the process, especially for magnets that require a low level of charge, is made more difficult because some magnetic domains ‘charge’ more easily than others but subsequently can lose their charge over a short period of time or when exposed to weak magnetic fields; other magnetic domains can be more difficult to charge but retain their level of magnetism for a considerable period of time (many years).

Because a set (at least one per string) of permanent magnets with differing charge levels is required to enable a magnetic pickup to deliver a balanced or a pre-selected total amplified output, the method 100 as described advantageously ensures that all permanent magnets which are magnetized or de-magnetized are more likely to retain their magnetization level over a long period of time.

The apparatus 150 comprises field coils configured to produce a strong magnetic field capable of magnetizing or de-magnetizing magnet members 20. By producing a strong magnetic field in one direction, this causes the magnetic domains in a permanent magnet, such as one of the magnet members 20, to become more aligned to the direction of the magnetic field, thereby increasing the magnetization of the magnet member 20. By varying the magnetic field, i.e. by continually reversing the direction of the magnetic field (i.e. the ‘polarity’), and reducing the intensity of the field over a short period of time (a few seconds), the direction of magnetic domains become randomized and thereby cause the magnetisation of the magnet member 20 to decrease.

In the illustrated example of FIG. 4, the field magnets are pairs of electromagnets 152, otherwise known as ‘coil pairs’ 152, each electromagnet comprising a coil with a steel core. When a current is applied to the coil, the electromagnet produces a magnetic field having north and south poles at opposing ends of the steel core which is proportional to the current. By aligning the pairs of coils such that a north pole of one of the pair of electromagnets 152 is spaced apart from a south pole of the other of the pairs of electromagnets 152, it is well known that a controlled constant magnetic field can be generated in the space between the adjacent north and south poles by controlling the currents applied to the coils.

Generally speaking, a magnetic field can be generated by application of a direct current (DC) to the coil pairs 152 for magnetisation of the magnet member 20 which is placed between the north and south poles. Similarly, a varying polarity magnetic field can be generated by applying an alternating (AC) current for demagnetisation of the magnet member 20. The varying magnetic field comprises a magnetic field with reversing poles i.e. the direction of the magnetic field reverses.

In FIG. 4, the apparatus 150 has six electromagnets coil pairs 152 arranged side-by-side, each pair 152 with the opposing poles spaced apart for receiving the magnet members and where the magnetic field strength applied by the electromagnets 152 is typically at its greatest magnitude. Typically, one magnet member 20 will be treated at one time, by activation of one coil pair 152 in sequence, due to the high currents required during the process.

To facilitate the arrangement of magnets in the correct location within the coil pairs 152, a holding device can be configured for holding the magnet members 20 in the specific spaced-apart arrangement corresponding to the spacing of the active magnetic regions of coil pairs. The holding device can be in the form of a non-magnetic cartridge 166. The cartridge 166 can hold two or more, preferably six magnets at a time depending on how many magnet members 20 are required to be magnetized in a single process. A locating member, such as a pin at opposing ends of the cartridge 166 and matching locating indicia on the apparatus 150 facilitate positioning of the cartridge 166 in the apparatus 150. When the locating members and indicia are aligned this ensures that each magnet member 20 is aligned accurately with its respective coil pair 152.

Different modes of operation of the apparatus 150 allow for a different number of magnets 20 to be treated in a single process sequence, as would be required for example, in a pickup for a four-stringed instrument.

While the apparatus has six coil pairs 152, it can be understood by a person skilled in the art that only one or more pairs of coils could be used however this will require removal or replacement of the magnet member 20 once treated to complete a set of magnet members 20 for example, six members in a pickup for a six-string stringed instrument. Coil pairs 152 can be added or removed to cause more or less magnet members 20 to undergo the magnetization or de-magnetization process as detailed further in paragraphs below.

The apparatus also has a power supply 154 connected to the coil pairs 152. At least one processor 156 such as a CPU, microprocessor or the like, is configured so as to control the current applied to the coils 152 via the power supply 154. The at least one processor 156 is also connected to a memory (not shown) and is configured to execute a set of instructions stored in the memory.

Specifically, the at least one processor 156 is configured to control an electronic component which is capable of conducting current, supplied by the power supply 154, in either direction when triggered, such as a three terminal AC switch known as a ‘Triac’ 158. The apparatus 150 also has a set of relays 160 which connects the coil pairs 152 to the power supply 154 and is controlled by the at least one processor 156. The relays 160 allow the power supply 154 to be connected to a selected coil pair 152 for magnetization or demagnetization and then to switch to one of the other coil pairs 152 in sequence until all the magnet members 20 have undergone the magnetization or demagnetization process. The apparatus 150 can also have an on/off switch which may also be operated by the at least one processor 156.

The apparatus 150 may also have input and output devices connected to the at least one processor 156 which allow a user to add to, remove, execute or amend the instructions in the memory, such as a keyboard, mouse, and a display such as a computer monitor or LCD screen 162. Alternatively, the display could be part of a personal computing device such as a tablet, smart phone or the like, configured to be operated by the user via the touchscreen or other input mechanism which is connected to the at least one processor 156, via a communication means such as a network.

The instructions in the memory may contain several different sets of instructions, i.e. ‘modes’, for applying the method 100 to a set of magnet members 20 for different pre-selected amplified outputs. For example, in one set of instructions or mode, the method may be applied such that the set of magnet members 20 have pre-determined magnetic flux outputs cause the pickup to operate in a balanced mode for a set of strings in one type of guitar or a specific guitar. In another mode, the set of magnet members 20 have pre-determined magnetic flux outputs which cause the pickup to operate in a balanced mode where the volume levels of the strings are substantially the same, while yet another mode will cause the set of magnet members 20 have pre-determined magnetic flux outputs which cause the pickup to mimic the sound of a vintage guitar. Yet another mode may completely demagnetize the magnet members 20 for convenient storage or transport. At least eight different modes can be stored in the memory however it can be understood that the storage of additional instructions (modes) can be stored in the memory as required or desired.

The display 162 preferably shows a number of parameters of the magnetisation/demagnetisation process and preferably show one or more of the current modes, the starting delay, the progress of the method 100 and the On/Off status.

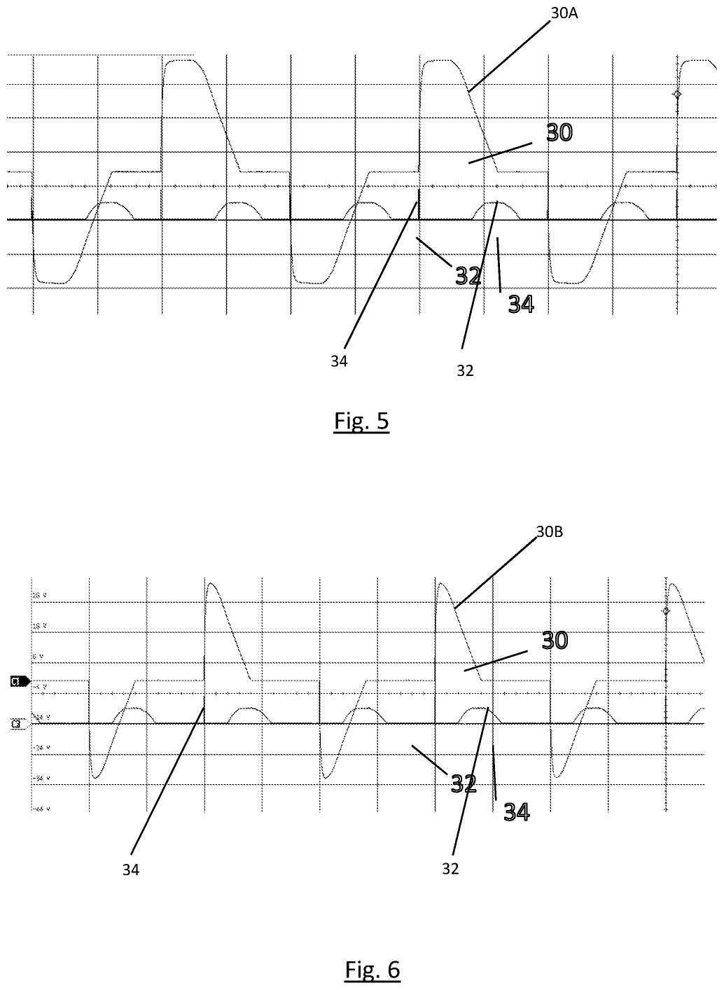

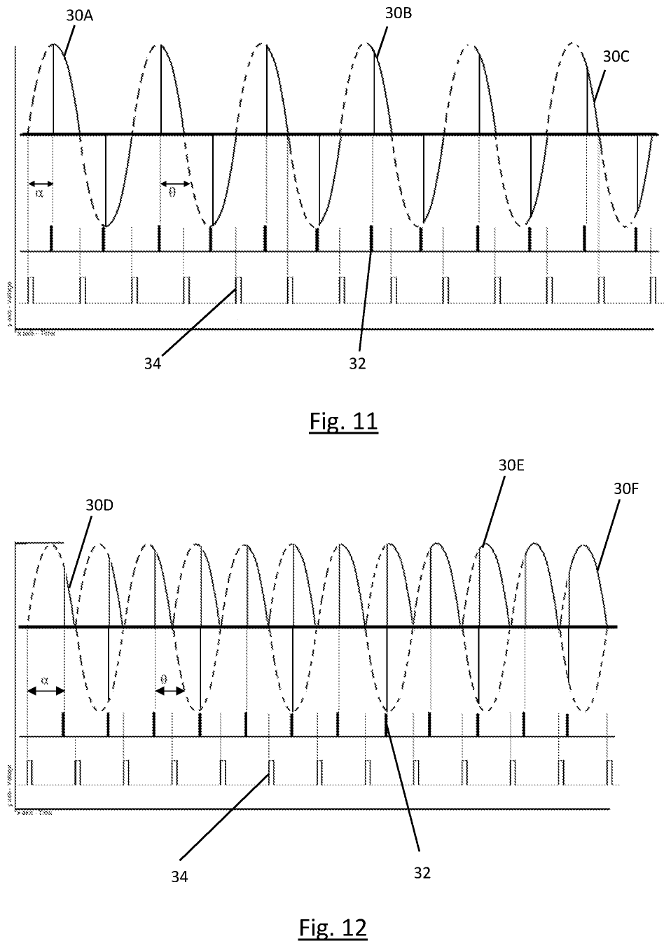

FIGS. 5 to 10 illustrate an example of the waveforms which are used to control the steps of magnetization and de-magnetization in the method 100 of the preferred embodiment which are summarised in the graphical representations of FIGS. 11 and 12. The waveforms are part of the overall train of pulses or ‘envelope’ which is applied to the power supply 154 which controls the current to the coil pairs 152.

In FIGS. 5 to 10, there are shown six waveform screen captures from an oscilloscope, each of which have three traces 30A to 30F, 32, 34 which assist to illustrate the method of the preferred embodiment in FIG. 3. FIGS. 11 and 12 is a representation of the development of corresponding traces 30A to 30F. A first trace 30A shows the power that is delivered by the Triac 158; this has a direct relationship with the current delivered to the coil pairs 152 for effecting the magnetic flux and direction output between the coil pairs 152. The widest half-periods indicate those with the highest energy level (Triac 158 gated early in the cycle) and the narrowest half-periods indicate those with the least energy (Triac 158 gated late in the cycle).

The graphical representations of FIGS. 11 and 12 show how the overall ‘envelope’ changes with time (as shown in the waveforms of the solid lines which represent the conduction duration). The trace 32 is the Triac (158) gate trigger pulse from the microcontroller 156 and trace 34 is the 10 ms output pulse train from the zero-crossing detector 164. α is the Triac gate trigger angle while θ is the conduction angle. FIG. 11 shows the AC pulse demagnetizing waveform envelope where the conduction duration and intensity decrease with time (solid lines) from traces 30A to 30C. FIG. 12 shows the DC pulse magnetizing waveform envelope where the conduction duration and intensity increase with time (solid lines) from traces 30D to 30F. The half periods of the sine curve below the zero level (dotted lines) represent the negative part of the original AC waveform blocked by the full wave bridge rectifier.

A second trace 34 shows the 100 Hz output of the Zero Crossing detector 164 which is configured to send a signal to the at least one processor 156, via an optocoupler whenever the current switches polarity, i.e. the zero-crossing point. The zero-crossing point occurs at twice the mains frequency period (50 Hz in this case) and therefore the signal triggers one pulse for the positive half-period of one complete cycle of the mains waveform and one for the negative half-period, via an optocoupler which is for controlling the synchronization of the Triac gating. A third trace 32 of the waveforms of FIGS. 5 to 10 (this aligns with the beginning of the pulses of the first trace showing the power delivered by Triac) is the computer output pulse that gates the Triac via an optocoupler.

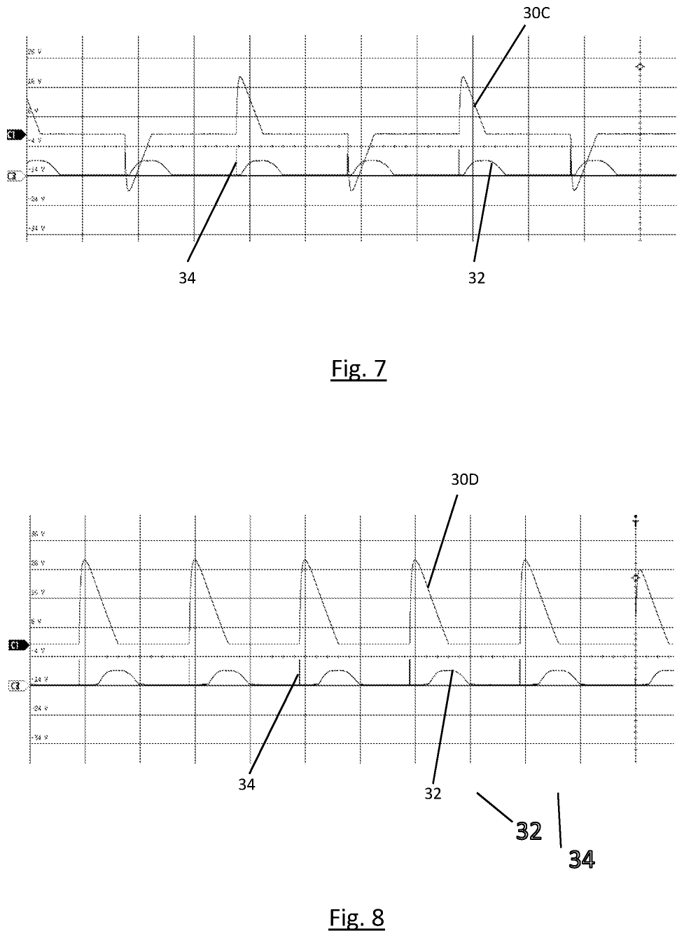

FIGS. 7 and 8 illustrate in more detail the step 106 of demagnetization of the magnet members 20 which follows once the magnet members 20 have been removed from the pickup if necessary and received within the designated spaces between the coil pairs 152. In particular, FIGS. 7 and 8 illustrate example waveform captures of portions, i.e. oscilloscope traces 30B and 30C respectively, of the power envelope of the demagnetizing step which applies an AC power/current to the coil pair 152 to produce a suitable level of magnetic flux for demagnetisation of the magnet member 20. The AC current causes the magnetic field between the coil pairs 152 to reverse direction, i.e. reverse polarities, the field is then gradually reduced to a minimal level and causes the direction of the magnetic domains in the magnet member 20 to randomize and thus demagnetizes the magnet member 20.

The at least one processor 152 is configured to send a signal or series of signals (also known as ‘gating’) to the Triac 158, which responds by switching on early in each waveform half-period which delivers the high-powered train of pulses which creates a strong alternating magnetic field in the electromagnet coil pairs 152. Each pulse has a fixed time period which is less than 10 milliseconds. By gating the Triac 158, later and later in each successive waveform half-period, this causes a decrease in the power and current applied to the coils and thus reduces the strength of the alternating magnetic field to a very low level, limited by the latest part of the waveform half-period at which the Triac is capable of operating. Due to several limiting factors including opto-coupler switching times and transient high voltage and current spikes when switching inductive loads (coil pairs) the gating period of the Triac 158 is kept between 500 uSecs and 6750 uSecs of each half-period for stable operation. At the end of the cycle in step 106, the permanent magnet member 20 is effectively demagnetized to zero or to at least a level of about 3-10% of the potential flux level (i.e 3-10 mT) of a typical AlNiCo magnet used in a magnetic pickup; this process is especially effective for this type of magnet.

FIGS. 5 and 11 show that the waveforms initially begin with higher energy. The Triac is being gated quite early in each half-period and thus has about 70% of the power of a “full” half period indicating that the magnet member 20 is subjected to an alternating magnetic field having a power of about 70% of the total magnetic flux of the pulse.

The power of the alternating magnetic field is gradually reduced as the Triac 158 responds to a signal such as a gating signal from the at least one processor 152 to switch on later and later in the half-period which effectively reduces the power applied to the coil pair 152 and reduces the magnetic field strength applied to the magnet member 20. As illustrated in FIGS. 6 and 11, the power applied to the coils is reduced to about 30% where the magnet member 20 is subjected to an alternating magnetic field having a power of about 30% of the total magnetic field strength of the pulse.

Finally, at the end of the demagnetization step 106 and at the end of the pulse envelope, as illustrated in FIGS. 7 and 11, the Triac 158 responds to a signal, such as a gating signal, from the at least one processor to switch even later in the cycle of the half-period and thus the power applied to the coils is reducing even further to about 10% before the at least one processor 152 ceases to supply gating pulses to the Triac and the power to the coil pair is terminated. Thus, at the end of the pulse envelope in step 106, the alternating magnetic field affecting the magnet member 20 is substantially zero.

By having a demagnetization step 106 where the alternating magnetic field strength applied to the magnet member 20 is initially high (where the power/current applied to the coil pair 152 is high) and then gradually reduces to effectively zero over a period of time, for example a few seconds; results in a full demagnetization of the magnet member 20 being treated. By fully demagnetizing the magnet member 20, this treats the magnet member 20 so that there is a more consistent end result during the magnetization step.

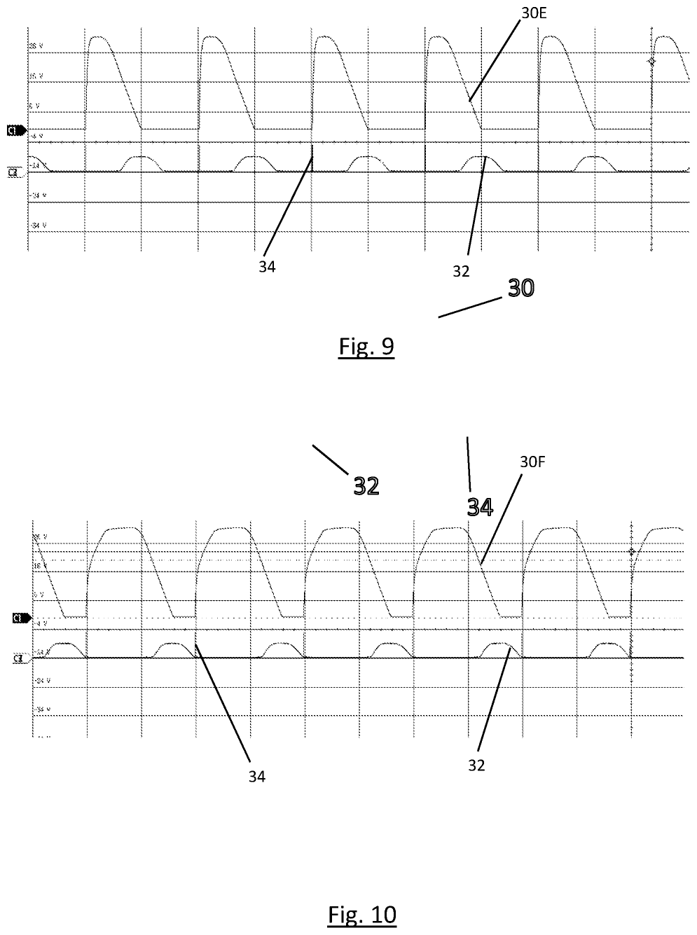

FIGS. 8 to 10 are views which illustrates the step of magnetization 110 of each magnet member 20 which follows the step of demagnetisation 114 with a series of waveform screen captures, i.e. oscilloscope traces 30D, 30E and 30F respectively, from the oscilloscope which is summarised in the graphical representation of FIG. 12. Notably, the power envelope is the opposite of the demagnetization cycle; it starts with a low power/current level (about 10%), i.e. oscilloscope trace 30D, in FIGS. 8 and 12 and then increases to higher power/current (about 90%) level, i.e. oscilloscope trace 30F, in FIGS. 9 and 12. Similarly, to the demagnetisation step, the at least one processor 152 sends a signal which can be in the form of a series of gating pulses to the Triac 158 which responds by switching earlier in succeeding pulses of the power envelope. As such the negative half-periods have been inverted and are all positive (above zero volts DC). As the power supply is DC, i.e. the direction of the current does not vary, and thus the direction of the magnetic field applied to the magnet member 20 also does not vary, and therefore the magnetic domains in the magnet member 20 are gradually aligned in the same or similar direction thereby magnetizing the magnet member 20.

In the magnetization step 110, the magnet member 20 is magnetized to a higher charge level than the final magnetization level which is required such that the magnet member 20 outputs a magnetic flux that has been pre-determined to take into account the parameters of the string being amplified to produce a particular amplified output i.e. a particular volume level. For example, the higher magnetization level can be at least 10% of the final magnetization level. In another example, the higher magnetization level can be at least 20% of the final magnetization level. The higher magnetization level can depend on the material composition of the magnet material and other factors.

After the magnetization step 110, the magnet member 20 is then de-magnetized in step 114, by a series of alternating power/current pulses or power envelope where the pulses gradually reduce in power to a magnetization level where the magnet member 20 is able to output a magnetic flux that has been pre-determined to take into account the parameters of the string to produce a particular amplified output. The step of de-magnetization 114 after magnetization 110 to a higher level reduces or eliminate the easily magnetizable (and de-magnetizable) domains for the long-term stability of the magnet member 20.

As an example, a fully charged AlNiCo5 magnet is about 100-120 mT (milliTesla), a peak measurement using a meter measured on the surface. If we wanted to charge a magnet to 50 mT we would most likely charge it to 60-70 mT and then apply a demagnetizing force of say 150 mT (fraction of the range (250 mT to 350 mT) to bring it closer to the pre-determined level.

In steps 108, 112, 118, a meter, for example a gauss meter, is used to test the magnetic flux of the magnet member 20 to ensure it is at the expected magnetic flux, i.e. whether it is substantially at the pre-determined magnetic flux magnitude (or within ±10%), or whether it has been correctly de-magnetized. Alternatively, a sensitive spring gauge is used to test the “pull-strength” of the magnet in grams; this is the industry standard for testing permanent magnets.

The applicant has found that once a defined “power envelope” has been set for a specific charge level for a certain dimension and composition of a permanent magnet, the magnetic flux usually falls within a precision of within a 10-15% margin of error; this is unnoticeable sonically in the instrument as there is much more variation in the string volume level from variations in a player's picking intensity. To achieve a pre-selected total amplified output from a set of strings, each magnet member 20 must have a pre-determined ‘charge’ which outputs a magnetic flux which takes into account the permeability of the string and a range of other factors to as to allow a pre-selection of a total amplified output i.e. where the volume levels of each string is in a specific relationship with each other.

An important factor in the process is the composition of the magnet members and also their physical size; this will affect the maximum charge and strength capability of each magnet member 20. Most of the magnets used in 6-string guitar pickups are either made from AlNiCo, an alloy made mainly from aluminium, nickel and cobalt or a ceramic material. This alloy comes in several types such as AlNiCo 2, AlNiCo 5 and AlNiCo 7 with the most commonly used up to date being AlNiCo 5.

With nickel strings used in electric guitars, the charge of the six permanent magnets used in a pickup is usually quite similar with only a variation of about 20-25% between the magnets.

With phosphor bronze strings, the 6th, 5th, 4th and 3rd strings have a permeable (magnetizable) core with the outer wrap consisting of phosphor bronze which is effectively a non-permeable material. The 3rd string has the thinnest core and hence is less magnetizable than the other strings and potentially produces the weakest output from the pickup. This string requires the strongest magnet followed by slightly weaker and weaker strength magnets for the 4th, 5th and 6th strings to balance their electrical output. The 1st and 2nd strings are plain nickel-coated steel which have relatively high permeability. These two strings require the weakest charge magnets to balance their electrical output with the four wound strings. String tension is also another important factor. The vibrational output of a string is dependent on the tension of the string when tuned to its correct pitch.

In relation to phosphor bronze strings, even though the steel core size of the 1st string is similar to that of the 4th string, it has a higher tension producing more vibrational (acoustic) output (and hence electrical output) than the 4th string which is tuned to a much lower pitch resulting in less tension. This is easy to prove by fitting two .012″ gauge strings to an acoustic guitar and tuning one to the 4th string pitch (D3) and the other to the normal 1st string pitch (E4). The 4th string will have a lesser vibrational or acoustic intensity than the 1st string. On a “normal” magnetic pickup, this would result in an imbalance of electrical output (and hence amplified volume) between the two strings. Adjusting the charge level of the respective magnets can correct this imbalance; a stronger magnet for the 4th string will increase its electrical output compared to the 1st string with a weaker magnet.

In another example, the 2nd (B) string & 3rd (G) string on an electric guitar used for Blues/Rock styles and fitted with light gauge nickel strings illustrates how output is affected by string gauge. The light gauge/low tension strings of this style of guitar cause the strings to deflect much more than the higher tension strings that might be used on a guitar used for jazz styles. Because of this problem, the magnets in a lot of pickups are usually set physically below the level of the magnets on other strings to achieve a more balanced result. Using a weakly-charged magnet for the 2^{nd} and 3^{rd} strings in this style of guitar is more effective and looks better from an aesthetic perspective.

Lastly, all instruments built with either a solid body or an acoustic chamber have a fundamental resonance. If it is excessive, the resonant frequency can often cause one string to have a greater output level than the others in the set. This could also be considered when balancing a set of magnets and would help even out the response of the instrument when played through an amplifier.

With regard to all the factors discussed above, determining the desired charge required for a magnet member 20 with regard to the magnet member 20 material composition and size and for each string type may be done by experimentation and experience. Further the determination involves testing various steps of demagnetization, magnetization, and demagnetization as described, with various magnet types to different charge levels and testing with regard to a particular string type, magnetic flux measurements and pull-strength. By thorough trial and error experimentation, of all types of magnets, with different types of strings, and different types of instruments, a set of data which can be presented in a graphical or tabular form which allows a user to determine a set of predetermined charges for a set of selected magnet members 20 which will amplify a set of strings to produce a pre-selected total amplified output.

In a preferred embodiment, a set of instructions, or ‘mode’ for execution by a processor can carry out the trial-and-error experimentation by slightly varying parameters to carry out the so as to form the basis of the data from steps of demagnetization, magnetization, and demagnetization as described, and by testing the magnetic flux and pull-strength of the magnet members 20 thereafter.

In another preferred embodiment, the apparatus 150 can be configured to display a plurality of modes which are stored in the memory including modes representing the de-magnetization or magnetization processes as described above. The user can select one or more from the plurality of modes, via an input device, for example via a menu system displayed on a computer monitor or a personal computing device. The different modes that are selectable for treatment of the magnet members for a pickup which output is configured for at least one of the following: a variety of different types of guitars; to mimic the sound of different specific guitars; to mimic the sound of different vintage guitars; to accommodate different gauges of strings, to compensate for the material composition of the strings i.e. phosphor bronze or nickel alloy, and so on. The modes may specifically also include pre-set arrangements for manufacturers, such as the applicant, to apply the method 100 to a set of magnet members 20 to have a particular output, such as a balanced output or a pickup output to mimic certain guitar sounds.

Although the apparatus 150 is illustrated in the example of FIG. 4 as having six relays, the apparatus 150 may be configured to have additional relays, for example two additional relays to make a total of eight relays. An apparatus 150 having eight relays which allow connection of an additional coil pair to the six coil pairs 152 which allow the apparatus 150 to treat two additional magnet members 20 in the eight coil pairs 152. In this example, the apparatus 150 having eight coil pairs 152 could treat eight magnet members 20 for an eight-stringed guitar.

Alternatively, the apparatus 150 having eight coil pairs 152 could treat a set of six magnet members 20 in six of the eight coil pairs, while the additional two relays could be used for other modes of operation separate to the six coil pairs, i.e. external modes of operation. These additional external modes of operation may also be displayed on a display for user selection similar to the other modes.

In one preferred embodiment, the set of six magnet members are treated in the cartridge 166 so that the set of magnet members 20 are balanced before being installed in the pickup, for example a pickup for a six-stringed guitar. The use of the cartridge 166 is limited to magnet members which have not yet been installed in pickups because of the spacing between the magnet members 20 due to the size of the coils. Typically, the magnet members 20 installed in pickups are spaced about 10.5 mm apart. In comparison, the coil pairs are spaced apart by about 35 mm to achieve the flux levels required for the balancing process when the process treats the separate magnet members 20 in the cartridge 166.

Handling premade pickups with fully charged magnet members can be awkward especially when winding or wax-dipping as the magnet members attract each other or stick to any metal objects. Wax-dipping is performed to prevent microphonic, noise caused where electronic components convert mechanical vibrations into electrical signals where the mechanical vibrations can be caused by loose coil windings. The magnetic charge of the magnet members can be compromised when placed in the vicinity of stronger magnets especially if some have been charged to a low level as in the case of the magnets for pickups suited to Phosphor Bronze strings. Therefore, it is advantageous to first demagnetize the magnet members 20 to allow for easier handling when assembling the pickup. The magnet members 20 can then be magnetized and/or balanced after assembly of the pickup.

For example, one or each of the additional two coil pairs could be used for magnetizing magnet members 20 which are contained in the pickup that has been already manufactured and wound and/or wax-dipped. In this embodiment, it is not possible for all the magnet members 20 to be treated simultaneously and therefore each magnet member 20 which is already installed in the pickup must be processed one at a time. The user can select a sequenced mode of operation from the menu system whereby each magnet member 20 is processed in turn with the user able to stop and start the process as each magnet in positioned and re-positioned in the additional coil pair until all magnet members have been processed. If required, the apparatus 150 can include a device for adjusting the position of the pickup such that the magnet member 20, which is the subject of the magnetization process, is positioned accurately in the external coil-pair. In addition, pre-made pickups can be safely stored with demagnetized magnet members and then processed when required.

Additionally, the apparatus 150 having the two additional coil pairs can allow two pickups to be processed simultaneously. Further, the two additional coil pairs can be configured differently from the other coil pairs so as to allow for different sizes or types or pickups, different magnet member spacings or other configurations which would be expected to be modifiable by a person skilled in the art. This also obviates the requirement to produce closely spaced, high-output miniature coil-pairs (i.e. electromagnets) for pre-manufactured pickups.

The user may also be able to interrupt any of the modes of operation, for example the magnetizing or de-magnetizing process via the input device. The user may also be able to select a demo mode for demonstration of the device or a training mode to teach users to navigate the menu system, access the different features or modes, with or without a user manual.

The user may also be able to configure the menu system itself so as to add different modes, for example for adding modes which provide different power envelopes for testing purposes or for customising the balance of the pickup to achieve different outputs. In the apparatus 150 having a flash memory for storage of the modes, at least one menu option can be left blank for user customisation if required.

The instructions, which may be in the form of application software, used for the apparatus 150 can be updated as necessary, whether downloadable from a cloud-based service or via an external memory such as a USB stick. The software can be accompanied by an encryption code for verification of the update to prevent counterfeiting or copyright infringement.

Adjustment of the magnetic flux of a magnet member can comprise alteration by adding to or subtracting from the mass of the magnet member to correspondingly increase or decrease the magnetic flux output. Alteration of the mass of the magnet element may also include removal of part of the magnet member, for example by drilling into or cutting a portion of the magnet member if required.

Alteration of the mass of the magnet member may also include adding or subtracting at least one magnet element to or from the magnet member 20. As permanent magnets are naturally attracted to each other by bringing into proximity opposing poles of two magnets, the at least one magnet element is easily attachable and removable, by magnetic attraction, to the magnet member 20. However, to ensure a secure attachment, fastening means such as clips or adhesive, may be utilised to connect the one or more magnetic elements to the member 20. The at least one magnet element may be formed of the same or substantially similar material as the magnet member 20, however this is not essential. The magnetic material of the magnet element may be selected to assist in adjusting the magnetic flux of the magnet element.

To maintain an aesthetic appeal, alteration of the magnet member by removal or addition of mass to the magnet member at a part of the magnet member 20 which is not visually exposed. Typically, when the pickup is in-situ on an electric guitar, the magnet members are aligned perpendicularly to the strings and intermediate the strings and bridge such that one end portion of the magnet member faces outwardly and is visible, and the inwardly directed opposing end portion faces the bridge and is thus hidden from view. Therefore, by altering the magnet member at the inwardly directed opposing end portion of the magnet the overall aesthetics of the stringed instrument can be maintained.

In a particularly preferred example to accommodate the use of phosphor bronze string when used in a stringed instrument with other strings of higher permeability, the magnet member or ‘pole pieces’ of the highest output level strings (loudest when amplified) can either be shortened or hollowed out by drilling a hole from beneath to various depths to reduce their permeability and hence output level. By altering the magnet member at a non-visible position thereof, the aesthetic qualities remain un-changed.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method for delivering a pre-selected amplified output of a set of strings of a stringed instrument, the method comprising the steps of:
providing a magnet member associated with each string of the stringed instrument wherein each magnet member is configured to be arranged in a coil of a pickup mountable to the stringed instrument for detection and amplification of the vibration of the respective string; and
adjusting each of the magnet members such the strength of the magnetic flux output by that magnet member is in a pre-determined relationship with the strength of magnetic flux output by each of the other magnet members,
wherein the magnetic flux output by each of the magnet members facilitates amplification of the vibration of its respective string, when so vibrating, such that the amplified outputs of each of the strings combine to produce a pre-selected total amplified output and
wherein the step of adjusting each of the magnet members comprises magnetizing each of the magnet members to a predetermined level such that each of the magnet members outputs a respective pre-determined magnetic flux.

2. The method according to claim 1, wherein the pre-selected total amplified output is a combination of the amplified output of each vibrating string where the amplified output of each string has the same volume level or wherein the pre-selected total amplified output is the amplified outputs of the strings having volume levels corresponding to respective strings of a specific pre-selected instrument or playing style.

3. (canceled)

4. The method according to claim 1, comprising the step of, prior to magnetizing each of the magnet members to a pre-determined level, demagnetizing each of the magnet members.

5. The method according to claim 4, wherein the demagnetization of the magnet members comprises subjecting the magnet members to an alternating (AC) magnetic field, and wherein the magnetization of the magnet members comprises subjecting each of the magnet members to a DC magnetic field.

6. (canceled)

7. The method according to claim 6, wherein the step of magnetization of the magnet member further comprises magnetizing each of the magnet members to a higher magnetization charge level then de-magnetizing each of the magnet members to a predetermined charge level so that each of the magnet members outputs the respective predetermined magnetic flux.

8. The method according to claim 4, wherein, in the steps of magnetization or de-magnetization, the AC or DC magnetic fields comprise a series of magnetic pulses in a pulse envelope.

9. The method according to claim 8, wherein, in the step of de-magnetization, the magnitude of the alternating AC magnetic field is gradually reduced from a higher magnitude to a lower magnitude where each succeeding pulse is of lesser power than the one preceding it.

10. The method according to claim 9, wherein, in the step of magnetization, the magnitude of the alternating AC magnetic field is gradually increased from a lower magnitude to a higher magnitude where each succeeding pulse is of greater power than the one preceding it.

11. The method according to claim 1, wherein the magnitude of the pre-determined magnetic flux output by one of the magnet members is determined with respect to at least one of the following:
a permeability of the respective string which vibration is being amplified;
the magnitude of the pre-determined magnetic flux output by one of the magnet members is determined with respect to the material composition and/or size of magnet members; and
the magnitude of the pre-determined magnetic flux output by one of the magnet members is determined with respect to the string tension of the string which vibration is being amplified.

12.-14. (canceled)

15. The method according to claim 1, wherein the step of adjusting the magnet members includes adjusting one of the magnet member to output a higher magnetic flux for a respective string having a lower permeability than at least one other string in the set of strings.

16. (canceled)

17. The method according to claim 1, wherein the magnet member is removable from the pickup for adjustment of the magnetic flux to the predetermined output and replaceable thereafter and wherein, after the step of demagnetization of the magnet member, the method includes the step of replacing or inserting the magnet member in the pickup and wherein the adjustment of the magnetic flux of magnet member(s) to the predetermined output is made in the pickup.

18. The method according to claim 4, wherein, after the step of demagnetization of the magnet member, the method includes the step of replacing or inserting the magnet member in the pickup and wherein the adjustment of the magnetic flux of magnet member(s) to the predetermined output is made in the pickup.

19.-20. (canceled)

21. The method according claim 1, wherein adjustment of one of the magnet members includes altering the mass of each of the magnet members associated with each string such that each of the magnet members outputs the respective pre-determined magnetic flux.

22. A method for delivering a pre-selected amplified output of strings of a stringed instrument, the method comprising the steps of:
providing a magnet member for each string of the stringed instrument wherein the magnet members are configured to be arranged in a coil of a pick-up; and
adjusting the mass of each of the magnet members such the strength of the magnetic flux output by that magnet member is in a pre-determined relationship with the magnetic flux output by each of the other magnet members,
wherein the magnetic flux output by each of the magnet members, facilitates amplification of the vibration of its respective string, when so vibrating, such that the amplified outputs of each of the strings combine to produce a pre-selected total amplified output.

23. The method according to claim 22, wherein adjusting the mass includes removing mass by drilling or cutting the magnet members or wherein the or each magnet member have at least one magnetic element which is attachable to and removable from the magnet member for increasing or decreasing the mass of the or each magnet member.

24.-25. (canceled)

26. The magnetic pickup having at least one magnet member wherein the magnetic flux output of each of the magnet members is adjusted for the pre-selected total amplified output by a method according to any one of the preceding claims claim 1.

27. The method of determining the magnetic flux output of magnet members of a pickup for a stringed instrument for delivering a pre-selected amplified output of the strings of the instrument, including the step of determining the resultant magnetic flux output from a selected magnet member by the method of any one of claim 1 to 25 by collecting data of the resultant magnetic flux output when varying one or more the following parameters: magnet member material composition, magnet member size, string material composition, string mass per length, string permeability, string tension, acoustic properties of the stringed instrument and properties of the pickup.

28. (canceled)

29. A system for delivering a pre-selected amplified output of strings of a stringed instrument, the system comprising an apparatus for adjusting the magnetic fields of a set of magnet members, the magnet members being configured for use in a pickup, the apparatus comprising:
at least one pair of electromagnets, a pole of one of each pair being arranged to face the opposite pole of the other of the pair and having a space between the oppositely facing poles for receiving one of the magnet members;
a power supply connected to each of the at least one pair of electromagnets for adjustment of the magnetic flux of the magnet member received in the space;
a control device connected to the power supply for controlling the power supply, the control device comprising at least one processor, a memory and a set of instructions stored in the memory for adjusting each of the at least one magnet members to a predetermined level the magnetic flux output by each of the magnet members, facilitates amplification of the vibration of its respective string, when so vibrating, such that the amplified outputs of each of the strings combine to produce a pre-selected total amplified output.

30. The system according to claim 29, comprising multiple pairs of electromagnets and wherein one of the multiple pairs of electromagnets is for adjusting each magnet member of the pickup.

31. The system according to claim 29 or claim 30, wherein the step of adjusting each of the magnet members comprises magnetizing each of the magnet members to a predetermined level such that each of the magnet members outputs a respective pre-determined magnetic flux.

32-37. (canceled)
